(19) United States
(12) Patent Application Publication
(10) Pub. No.: US 2001/0050768 A1
(43) Pub. Date: Dec. 13, 2001

(54) Optical fiber distortion measurement device

(75) Inventors: Haruyoshi Uchiyama, Tokyo (JP); Yoshiyuki Sakairi, Tokyo (JP); Hiroshige Ohno, Tsukuba-shi (JP); Hiroshi Naruse, Tokyo (JP)

Correspondence Address: DARBY & DARBY P.C., 805 Third Avenue, New York, NY, 10022, US

(73) Assignee: Ando Electric Co., Ltd

(21) Appl. No.: 09/872,449

(22) Filed: Jun. 1, 2001

(30) Foreign Application Priority Data
Jun. 13, 2000 (JP) 2000-177482

(51) Int. Cl. G01N 21/00

(52) U.S. Cl. 356/73.1

(57) ABSTRACT

The output light from a light source 10 is incident upon an optical fiber to be measured via an optical directional coupler 11, an optical switch 12, an optical amplifier 13, and an optical directional coupler 14. Light from the optical directional coupler 11 is incident upon a polarization controller 16. The output light from the polarization controller 16 and light returned from the optical fiber 15 are incident into an optical balance circuit 17, and these light are interfered. A fixed frequency, or alternatively a frequency which is varied stepwise, is output from a voltage control oscillator 18, according to a control signal from a DC voltage generation circuit 19 or from a saw tooth wave generation circuit 20. The output of the optical balance circuit 17 and the output of the voltage control oscillator 18 are mixed together by a mixer 26.

### BACKGROUND OF THE INVENTION

1. Field of the Invention

The present invention relates to an optical fiber distortion measurement device, and more particularly relates to an optical fiber distortion measurement device which, for an optical fiber, can perform determination of the situation with regard to generation of distortion and the specification of the location of such distortion in real time.

2. Description of the Related Art

FIG. 5 is a block diagram showing the structure of an optical fiber distortion measurement device according to the prior art. Referring to this figure, a light source emits coherent light of a reference frequency to to an optical directional coupler 111. This coherent light passes through the optical directional coupler 111 and, as coherent light, is emitted to a frequency conversion section 130.

After converting this coherent light to pulse light by an optical switch 130a, the frequency conversion section 130 repeatedly performs frequency shifting by a frequency shift loop which comprises an optical directional coupler 130b, an optical amplifier 130c, a delay optical fiber 130d, an optical BPF (band pass filter) 130e, and an optical frequency shifter 130f, and, as a result, outputs to an optical switch 112 a light signal whose frequency has been shifted by a predetermined frequency Δf exactly. The frequency of the light signal is f0+Δf.

After the optical signal has been converted into pulse light by the optical switch 112, it is emitted via an optical amplifier 113 to the optical fiber 115 to be measured via an optical directional coupler 114. When this pulse light is incident upon it, a reflected image or a scattered image is generated in the optical fiber 115 to be measured according to the state of the fiber, and the portion of this light which is reflected is emitted via the optical directional coupler 114 to an optical balance circuit 117.

The optical balance circuit 117 converts this returning light into an electrical signal according to the balance of this received light with the coherent light of frequency to which is emitted from the optical directional coupler 111 via a polarization controller 116. This electrical signal is inputted to an A/D converter 123 via a low band pass filter 121 and an amplification section 122, and, after being A/D converted therein, is then input to a signal processing section 124. This signal processing section 124, apart from deriving the various characteristics of the optical fiber 115 to be measured based upon this electrical signal which has been inputted, also obtains the distribution upon the distance axis of the optical fiber to be measured by processing this electrical signal with respect to the time axis. And a waveform display section 125 displays the results of processing by the signal processing section 124.

However, with the above described optical fiber distortion measurement device according to the prior art, there has been a limit upon the output interval of the pulse light which is the measurement light, since it is necessary to send the frequency component of the pulse light which is to be the light for measurement a predetermined number of times around the loop which includes the frequency shifter and so on so as to frequency convert it using the optical frequency conversion section 130, in order to obtain the desired frequency. Due to this, it is not possible to output the optical pulses at a period which is most suitable for the length of the optical fiber to be measured, and, in particular, a time much greater than necessary is required when measuring a short fiber.

Further, in order to obtain the Brillouin spectrum, it is necessary repeatedly to perform sweep measurement for each of frequencies which have been set at an interval in a predetermined frequency zone, and there has been the problem that the time for measurement has become excessively long. Due to this, a time of two minutes or more, for example, is required for a single distortion measurement, and there has been the deficiency that it has not been possible to measure distortion which is instantaneously generated and disappeared (or changed).

The present invention has been conceived of in the light of these considerations, and its objective is to provide an optical fiber distortion measurement device which is able to measure the entire Brillouin spectrum waveform of an optical fiber in real time.

### SUMMARY OF THE INVENTION

In order to solve the above identified problems and attain the above identified objective, an optical fiber distortion measurement device of the present invention comprises: light source; a first optical directional coupler which separates light from the light source into two directions; an optical switch upon which is incident one of outputs of the first optical directional coupler, and which either modulates the light into pulse light or outputs it without modulation; a second optical directional coupler which conducts output from the optical switch to an optical fiber to be measured; a polarization controller to which is input the other of the outputs of the first optical directional coupler; an optical balance circuit to which are supplied output from the polarization controller and light which is returned from the optical fiber to be measured via the second optical directional coupler, and which combines them and outputs electric signals; a voltage control oscillator which generates an AC signal whose frequency is based upon output of a DC signal generation circuit or upon output of a saw tooth wave signal generation circuit; and a mixer which mixes output of the optical balance circuit and output of the voltage control oscillator.

According to the present invention, not only is it possible to measure the Brillouin spectrum waveform for the entire optical fiber in real time and to determine whether or not any distortion is taking place by selecting the control signal for the voltage control oscillator, but also the benefit is obtained that it is possible to detect the location of occurrence of distortion in real time by measuring the Brillouin backscattering waveform and processing it with reference to the time axis.

This device may further comprises an amplifier which amplifies output from the optical switch and introduce amplified light into the second optical directional coupler; a filter circuit which cuts high frequency component in output of the mixer; an amplifier which amplifies output of the filter circuit; an A/D converter which converts output of the amplifier into a digital signal; and a signal processing section which processes output of the A/D converter.

The optical switch may output light which is incident upon it from the first optical directional coupler just as it is without modulation. In this case, the voltage control oscillator generates an AC signal of frequency which is based upon the output of the saw tooth wave signal generation circuit, and the signal processing section performs predetermined signal processing synchronously with the output signal of the saw tooth wave signal generation circuit, and detects the Brillouin spectrum over the entire length of the optical fiber to be measured in real time.

The optical switch may the optical switch modulates the strength of the light which is incident upon it from the first optical directional coupler into pulse light. In this case, the voltage control oscillator generates an AC signal of frequency which is based upon the output of the DC signal generation circuit; and the signal processing section detects Brillouin backscattering waveform and determines the location of distortion in real time by processing the differences in level of the Brillouin backscattering waveform with respect to the time axis.

### BRIEF DESCRIPTION OF THE DRAWINGS

FIG. 1 is a block diagram showing the structure of an optical fiber distortion measurement device according to the preferred embodiment of the present invention.

FIGS. 2A to 2C are graphs showing the results of measurement by this optical fiber distortion measurement device, and show the Brillouin spectrum waveform (for the entire optical fiber) in the case that no distortion is present.

FIGS. 3A to 3C are graphs showing the results of measurement by this optical fiber distortion measurement device, and show the Brillouin spectrum waveform (for the entire optical fiber) in the case that distortion is present.

FIG. 4 is a graph showing the results of measurement by this optical fiber distortion measurement device, and shows a Brillouin scattering light waveform which has been measured with the frequency of a signal which is outputted from a voltage control oscillator 18 being v′B(0).

FIG. 5 is a block diagram showing the structure of an optical fiber distortion measurement device according to a prior art.

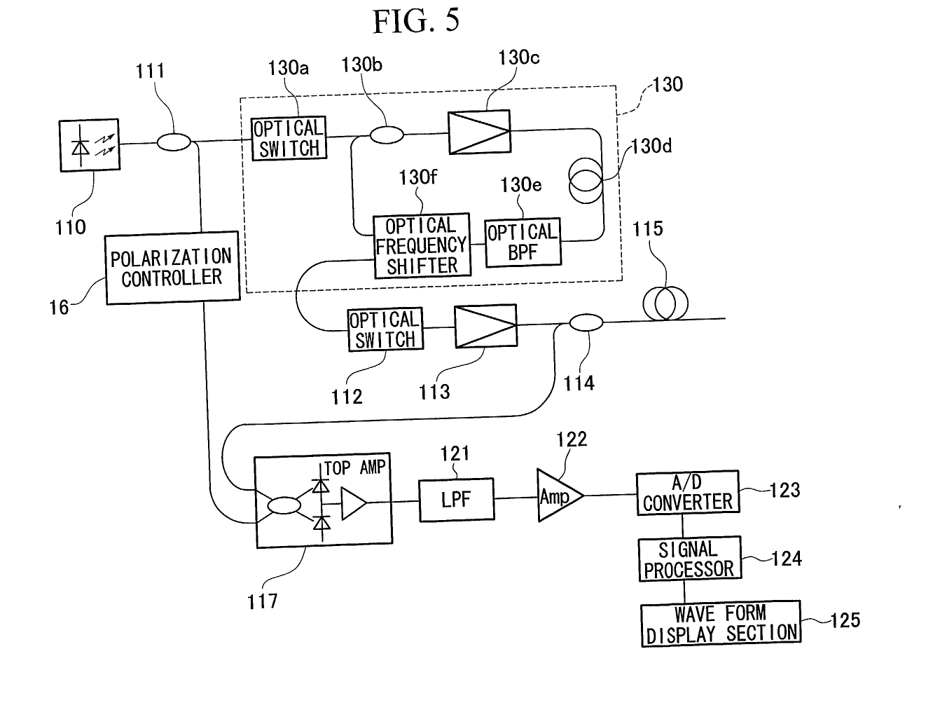

### DETAILED DESCRIPTION OF THE PREFERRED EMBODIMENTS

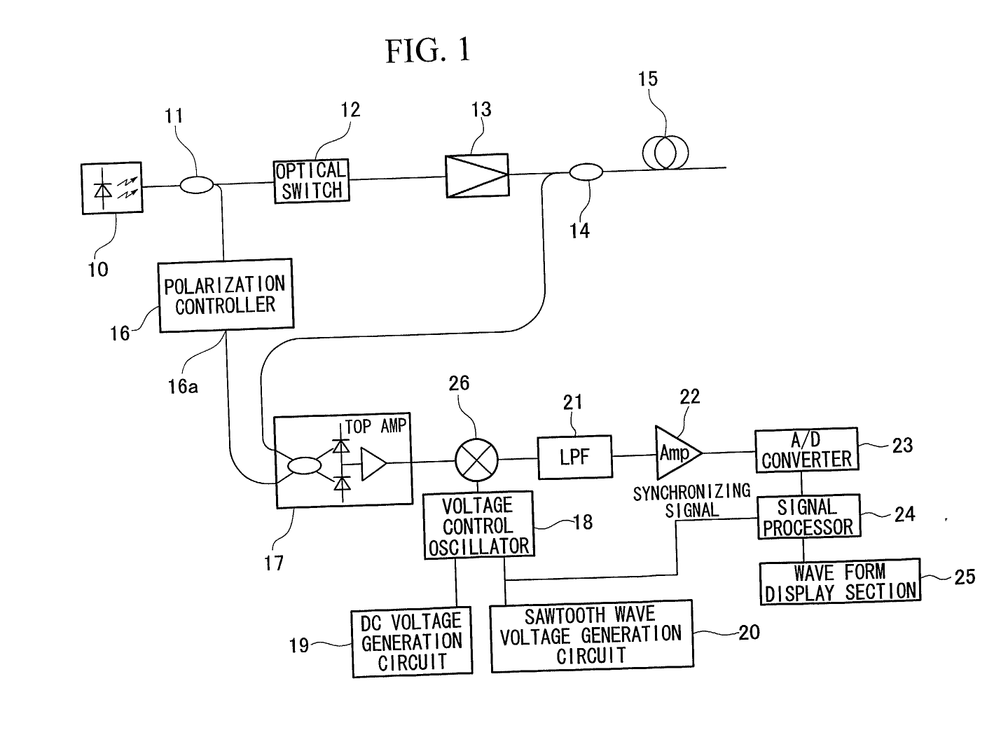

In the following, a preferred embodiment of the present invention will be explained with reference to the drawings. FIG. 1 is a block diagram showing the structure of an optical fiber distortion measurement device according to this preferred embodiment.

In this embodiment, a light source 10 is for example a DFB-LD (distributed feedback laser diode) which emits coherent light of a narrow band width in the 1.55 μm band. An optical directional coupler 11 is a 1×2 optical directional coupler with a single incident port 1 and two emission ports 2, and it divides coherent light which is incident into the incident port and emits it from the two emission ports. An optical switch 12 is, for example, an electrical/optical (E/O) switch which has two modes A and B, and, when this switch is turned ON, if it is in mode A, continuous light (coherent light) which is incident is converted into pulse light of a pulse width of from several nanoseconds to several microseconds, while if it is in mode B such continuous light which is incident is output just as it is without alteration. The pulse width is determined according to the spatial resolution which is required. Further, the period of generation of this pulse light depends upon the length of the optical fiber to be measured, and if the length of the optical fiber is, for example, in the length range of 10 km, this generation period may be 200 μs, while if it is in the length range of 1 km, this generation period may be 20 μs.

The optical amplifier 13 may for example be an optical fiber amplifier which employs an Er-doped fiber, and it amplifies the incident light signal to a predetermined level and emits it. The optical directional coupler 14 comprises an incident port, an emission/incident port, and an emission port, and, along with emitting the light signal which is incident from the light amplifier 13 to the optical fiber 15 to be measured, it also emits to its emission port the light which is returned from the optical fiber 15 to be measured.

This returned light, with respect to the optical signal which was emitted to the optical fiber 15 to be measured, contains Brillouin scattering light of which frequency is shifted by several GHz, or is Rayleigh scattering light for which frequency shifting has not entirely occurred.

The polarization controller 16 is, for example, a polarization rotator which is made up of a ½λ polarization plate and a ¼λ polarization plate, and it controls the state of polarization of the coherent light which is incident upon it, for example by rotating it randomly.

An optical balance circuit 17 is an optical balance circuit which comprises a high speed / high band PD (photodiode) or the like, and it performs input light optical balancing by combining the waveforms of the coherent light from the polarization controller 16 whose polarization state has been randomly controlled, and the returned light such as Brillouin scattering light or Rayleigh scattering light or the like. The band of the optical signal which is received is limited by the band of the photodiode and of the top amplifier which are included in this optical balance circuit 17, and may be for example from DC to 15 GHz.

A voltage control oscillator (VCO) 18 is controlled by the output signal of a DC voltage generation circuit 19 or of a saw tooth wave voltage generation circuit 20. If under the control of the voltage control oscillator 18, it outputs a signal of a fixed frequency. In contrast, if under the control of the saw tooth wave voltage generation circuit 20, it outputs a signal whose frequency is changed stepwise. The mode of the previously described optical switch 12 is changed over according to the output of this voltage control oscillator 18. The optical switch 12 is put into its mode A in which it outputs pulse light when the voltage control oscillator 18 outputs a signal of a fixed frequency, while it is put into its mode B in which it outputs continuous light when the voltage control oscillator 18 outputs a signal whose frequency is changed stepwise.

The mixer 26 combines the waveforms of the electrical signal which is output by the optical balance circuit 17 and the signal which is output by the voltage control oscillator 18, and outputs an electrical signal whose frequency is reduced by just the output frequency of the voltage control oscillator 18. The electrical circuit after this mixer 26 (that is, a low pass filter 21, an amplification section 22, and an A/D converter 23) is only required to be capable of processing a signal restricted to, for example, the DC to 1 GHz band.

The low pass filter 21 eliminates the high frequency component such as noise etc. included in the signal which is outputted from the mixer 26. The amplifier 22 amplifies the signal which is output by the low pass filter 21 to a suitable level. The A/D converter 23 converts the signal which is output by the amplifier 22 from an analog signal to a digital signal. The signal processing section 24 performs averaging processing and the like upon the digital signal which it inputs, and obtains distortion and loss characteristics for the optical fiber to be measured.

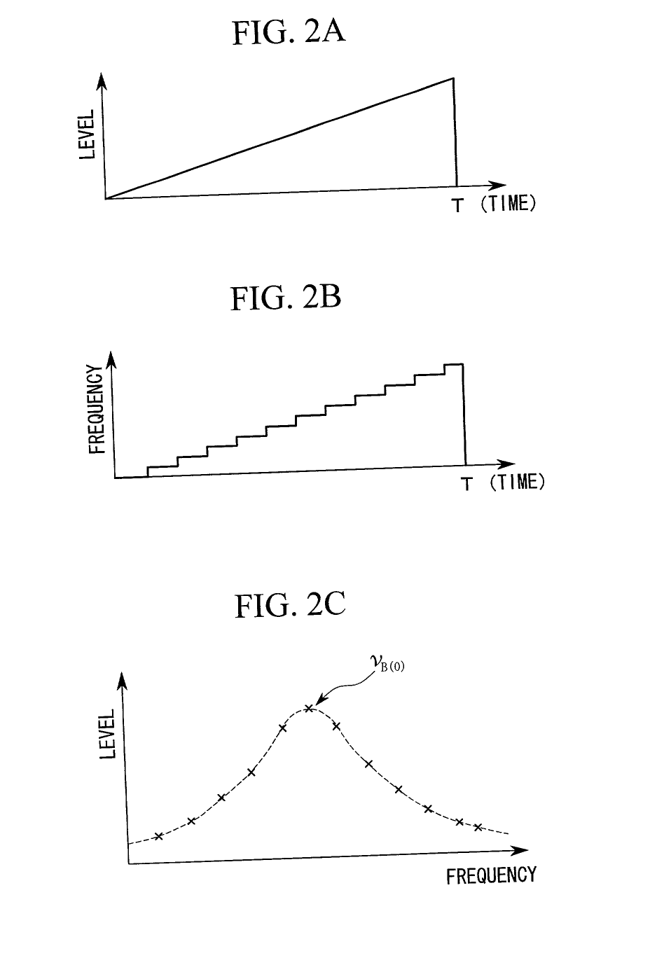

If the output of the saw tooth wave voltage generation circuit 20 is used as the control signal for the voltage control oscillator 18 described above, then the frequency of the signal which is outputted from this voltage control oscillator 18, for example, is varied in steps of 10 MHz in the range of 10.700 GHz to 11.000 GHz. By synchronizing the timing of the signal processing (sampling) of the signal processing section 24 with this saw tooth wave signal, it is possible, as shown in FIGS. 2A to 2C, to obtain the Brillouin spectrum (peak frequency vB(0)) over the entire length of the optical fiber 115 to be measured.

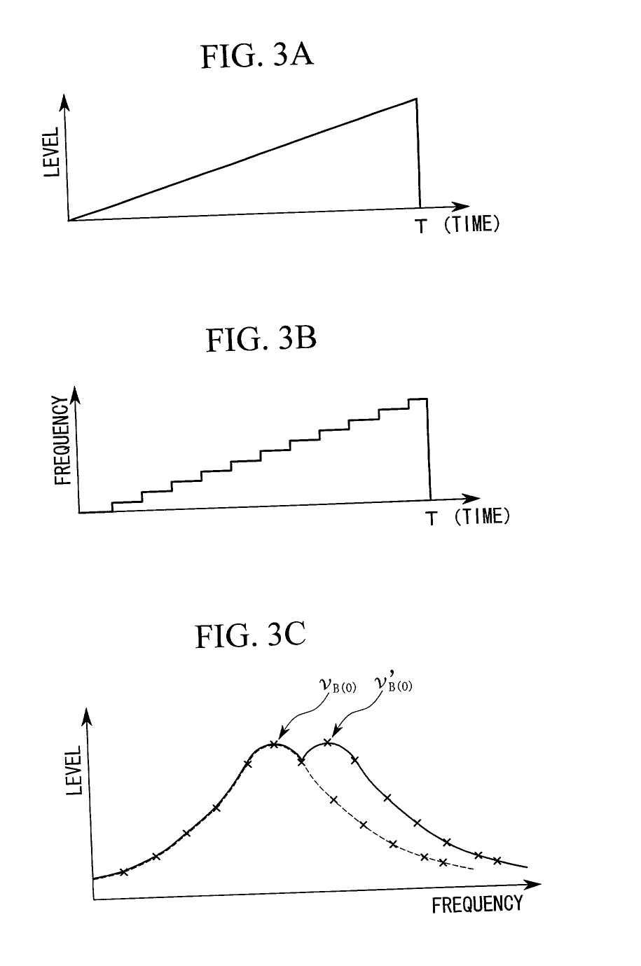

When distortion is occurring somewhere in the optical fiber 15 to be measured, a Brillouin spectrum is obtained in the same manner as described above, as shown in FIGS. 3A to 3C. Referring to this figure, the solid line shows the spectrum as actually measured, while the broken line shows what the spectrum would be if zero distortion were present. By detecting in this spectrum the peak frequency vB(0) at normal times (when zero distortion is present) and the peak frequency v′B(0) when distortion is present, it is possible to determine the amount of distortion which is occurring according to the following equation:

distortion (q)=(v′B(0)−vB(0))/vB(0)×c

where c is a distortion coefficient equal to approximately 4.78.

Further, even in the case that a clear peak frequency generated by distortion is not obtained in this manner, it is possible to determine whether or not distortion is occurring by detecting the difference in the waveform between a Brillouin spectrum for zero distortion which has been obtained in advance and the spectrum during actual measurement.

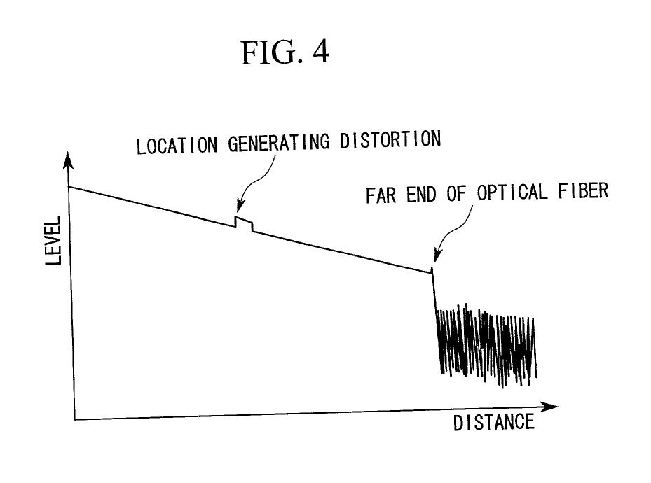

On the other hand, if the output of the DC voltage generation circuit 19 is used as the control signal for the voltage control oscillator 18, then the frequency of the signal which is outputted from this voltage control oscillator 18 is a fixed frequency which is determined by the DC voltage value. Thus it can be set to any desired value by the value of the DC voltage, and for example it may be 10.800 GHz. By synchronizing the timing of the signal processing by the signal processing section 24 to the switching by the optical switch 12, in other words to the output repetition period of the pulse light which is outputted by the optical directional coupler 14 to the optical fiber 15 to be measured, it is possible to obtain a Brillouin scattering light waveform upon the time axis (upon the distance axis) as shown in FIG. 4. FIG. 4 shows the Brillouin scattering light waveform which is measured with the frequency of the signal which is outputted from the voltage control oscillator 18 being v′B(0).

At this time, if any distortion is generated by the optical fiber 15 to be measured, a change takes place in the Brillouin scattering light waveform as shown in FIG. 4, and it is possible to detect from the position of this change the distance of the location where the distortion is being generated.

Further, instead of sequentially changing over the DC voltage, it would also be possible to obtain the Brillouin spectrum in the same manner as in the prior art method described above, by measuring the Brillouin scattering light waveform at various frequencies, for example from 10.700 GHz to 11.000 GHz.

Although the present invention has been shown and described in terms of a preferred embodiment thereof, and with reference to the drawings, it should not be considered as being limited by any of the perhaps purely fortuitous features of that preferred embodiment or of the drawings, but solely by the accompanying Claims.

What is claimed is:

1. An optical fiber distortion measurement device, comprising:
a light source;
a first optical directional coupler which separates light from said light source into two directions;
an optical switch upon which is incident one of outputs of said first optical directional coupler, and which either modulates the light into pulse light or outputs it without modulation;
a second optical directional coupler which conducts output from said optical switch to an optical fiber to be measured;
a polarization controller to which is input the other of the outputs of said first optical directional coupler;
an optical balance circuit to which are supplied output from said polarization controller and light which is returned from the optical fiber to be measured via said second optical directional coupler, and which combines them and outputs electric signals;
a voltage control oscillator which generates an AC signal whose frequency is based upon output of a DC signal generation circuit or upon output of a saw tooth wave signal generation circuit; and
a mixer which mixes output of said optical balance circuit and output of said voltage control oscillator.

2. An optical fiber distortion measurement device according to claim 1, further comprising:
an amplifier which amplifies output from said optical switch and introduce amplified light into said second optical directional coupler;
a filter circuit which cuts high frequency component in output of said mixer;
an amplifier which amplifies output of said filter circuit;
an A/D converter which converts output of said amplifier into a digital signal; and
a signal processing section which processes output of said A/D converter.

3. An optical fiber distortion measurement device according to claim 1, wherein:
said optical switch outputs light which is incident upon it from said first optical directional coupler just as it is without modulation;
said voltage control oscillator generates an AC signal of frequency which is based upon the output of said saw tooth wave signal generation circuit; and:
said signal processing section performs predetermined signal processing synchronously with the output signal of said saw tooth wave signal generation circuit, and detects the Brillouin spectrum over the entire length of said optical fiber to be measured in real time.

4. An optical fiber distortion measurement device according to claim 1, wherein:
said optical switch modulates the strength of the light which is incident upon it from said first optical directional coupler into pulse light;
said voltage control oscillator generates an AC signal of frequency which is based upon the output of said DC signal generation circuit; and
said signal processing section detects Brillouin backscattering waveform and determines the location of distortion in real time by processing the differences in level of the Brillouin backscattering waveform with respect to the time axis.
